(19) United States
(12) Patent Application Publication
(10) Pub. No.: US 2018/0365409 A1
(43) Pub. Date: Dec. 20, 2018

(54) SERVICE PROVIDING SYSTEM, CARD SET USED IN SERVICE PROVIDING SYSTEM, AND METHOD FOR PROVIDING SERVICE

(71) Applicant: KYOCERA Document Solutions Inc., Osaka (JP)

(72) Inventor: Tadaaki AKIMOTO, Osaka (JP)

(73) Assignee: KYOCERA Document Solutions Inc., Osaka (JP)

(21) Appl. No.: 15/994,408

(22) Filed: May 31, 2018

(30) Foreign Application Priority Data
Jun. 19, 2017 (JP) 2017-119628

(51) Int. Cl. G06F 21/45; G06Q 40/02; G06K 19/04

(52) U.S. Cl. CPC G06F 21/45; G06K 19/042; G06Q 40/02

(57) ABSTRACT

A service providing system includes a service providing portion and an input portion. The service providing portion provides a predetermined service to a user. The input portion is where authentication information is input when the service providing portion provides the service, and authentication is performed based on the authentication information. A plurality of cards on which a plurality of authentication signs are indicated are provided to the user beforehand. The authentication information is composed of the plurality of authentication signs extracted from the plurality of cards.

### INCORPORATION BY REFERENCE

This application is based upon and claims the benefit of priority from the corresponding Japanese Patent Application No. 2017-119628 filed on Jun. 19, 2017, the entire contents of which are incorporated herein by reference.

### BACKGROUND

The present disclosure relates to a service providing system using cards, to a card set used in a service providing system, and to a method for providing a service.

As an example of a conventional service providing system, a service providing system is known which provides so-called Internet banking services (banking services including withdrawal, depositing, balance inquiry, and the like via the Internet). This service providing system includes a server (service providing portion) or the like and an input portion. If a user signs a contract for Internet banking services with a financial institution, one card on which a plurality of authentication signs comprising numbers are indicated in a matrix is issued for the user beforehand.

The server or the like is provided in the financial institution, and provides the Internet banking services to users. The input portion is provided in a personal computer (user terminal), and the personal computer is connected to the server via the Internet. When the server or the like provides the services, a user enters authentication signs indicated on the card via the input portion.

In the service providing system configured as described above, when the user accesses and logs into the website of the financial institution from the personal computer, the entry of authentication signs at designated positions on the card is requested by the server. When the authentication signs at the designated positions are input to the input portion, user authentication is performed. Here, the authentication signs at the designated positions constitute authentication information. Then, if the authentication has succeeded, the user can receive a desired Internet banking service.

### SUMMARY

According to a first aspect of the present disclosure, a service providing system includes a service providing portion and an input portion. The service providing portion provides a predetermined service to a user. The input portion is where authentication information is input when the service providing portion provides the service, and authentication is performed based on the authentication information. A plurality of cards on which a plurality of authentication signs are indicated are provided to the user beforehand. The authentication information is composed of a plurality of authentication signs extracted from the plurality of cards.

According to a second aspect of the present disclosure, a card set is composed of a plurality of cards on which a plurality of authentication signs are indicated in a dispersed manner. The plurality of authentication signs forms authentication information required when a service is provided by a service providing portion which provides a predetermined service to a user.

According to a third aspect of the present disclosure, a method for providing a service includes a service providing portion and an input portion. The service providing portion provides a predetermined service to a user. The input portion is where authentication information is input when the service providing portion provides the service, and the service providing system performs authentication based on the authentication information. Providing the service involves requesting, inputting, and providing. In requesting, the entry of the authentication information is requested by the service providing portion. In inputting, the authentication information is input to the input portion. In providing, the service is provided by the service providing portion based on the authentication information input. A plurality of cards on which a plurality of authentication signs are indicated are provided to the user beforehand. The authentication information is composed of a plurality of authentication signs extracted from the plurality of cards.

Further features and advantages of the present disclosure will become apparent from the description of embodiments given below.

### BRIEF DESCRIPTION OF THE DRAWINGS

FIG. 1 is a diagram showing an outline of a configuration of an example of an Internet banking system according to a first embodiment of the present disclosure;

FIG. 2 is an exploded perspective view showing an example of a card set used in the Internet banking system according to the first embodiment of the present disclosure;

FIG. 3 is a flow chart showing an example of a service providing process in the Internet banking system according to the first embodiment of the present disclosure;

FIG. 4 is a diagram showing an example of a login screen displayed on a display portion of a user terminal in the Internet banking system according to the first embodiment of the present disclosure;

FIG. 5 is a diagram showing an example of a menu selection screen displayed on the display portion of the user terminal in the Internet banking system according to the first embodiment of the present disclosure;

FIG. 6 is a diagram showing an example of an authentication information input screen displayed on the display portion of the user terminal in the Internet banking system according to the first embodiment of the present disclosure;

FIG. 7 is a diagram showing an outline of a construction of an example of an image forming system according to a second embodiment of the present disclosure;

FIG. 8 is a block diagram showing a configuration of an example of a multifunction peripheral in the image forming system according to the second embodiment of the present disclosure; and

FIG. 9 is a diagram showing an example of a menu selection screen displayed on a liquid display panel of the multifunction peripheral in the image forming system according to the second embodiment of the present disclosure.

### DETAILED DESCRIPTION

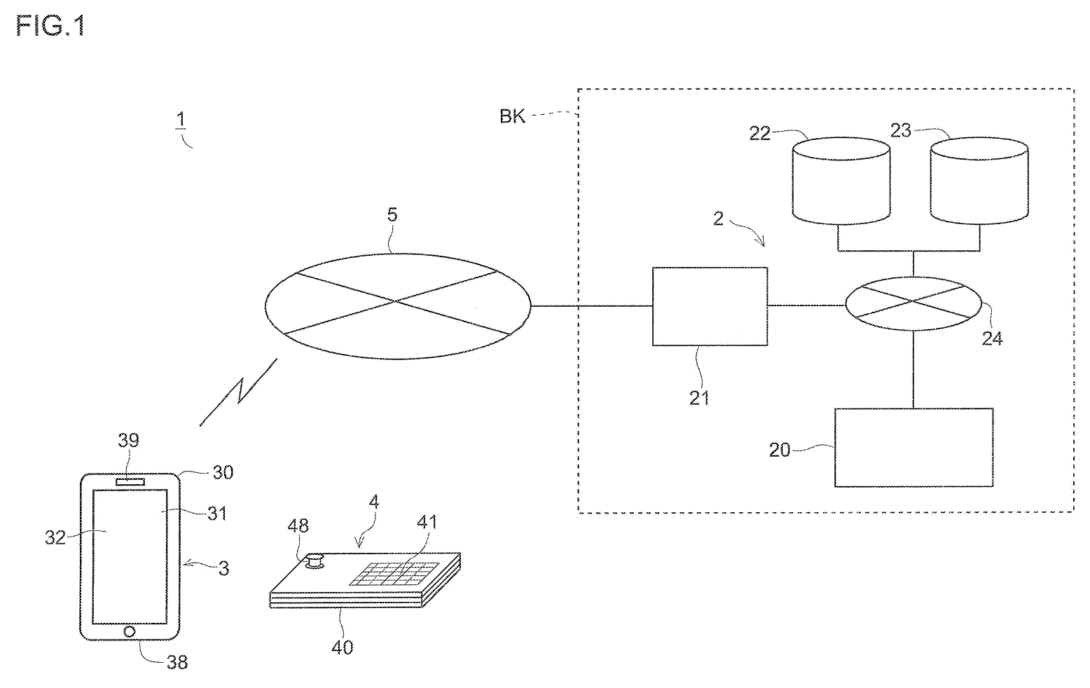

First Embodiment: Hereinafter, embodiments of the present disclosure will be described with reference to the accompanying drawings. FIG. 1 is a diagram showing an outline of a configuration of an Internet banking system according to a first embodiment. The Internet banking system (service providing system) 1 includes a financial institution internal system (service providing portion) 2 and a user terminal (information terminal) 3.

The financial institution internal system 2 is installed in a financial institution BK, and includes a host computer 20, a server 21, an account information storage 22, and a contractor information storage 23. The host computer 20, the server 21, the account information storage 22, and the contractor information storage 23 are connected to an in-house network 24 within the financial institution BK.

The host computer 20 performs account management of the financial institution BK. The server 21 is connected to the Internet (public network) 5 to provide Internet banking services to customers (users) via the Internet 5. The account information storage 22 stores account information on accounts opened in the financial institution BK, including account holders' names, customer management numbers, branch offices, account items, account numbers, account balances, transaction history statements, and the like.

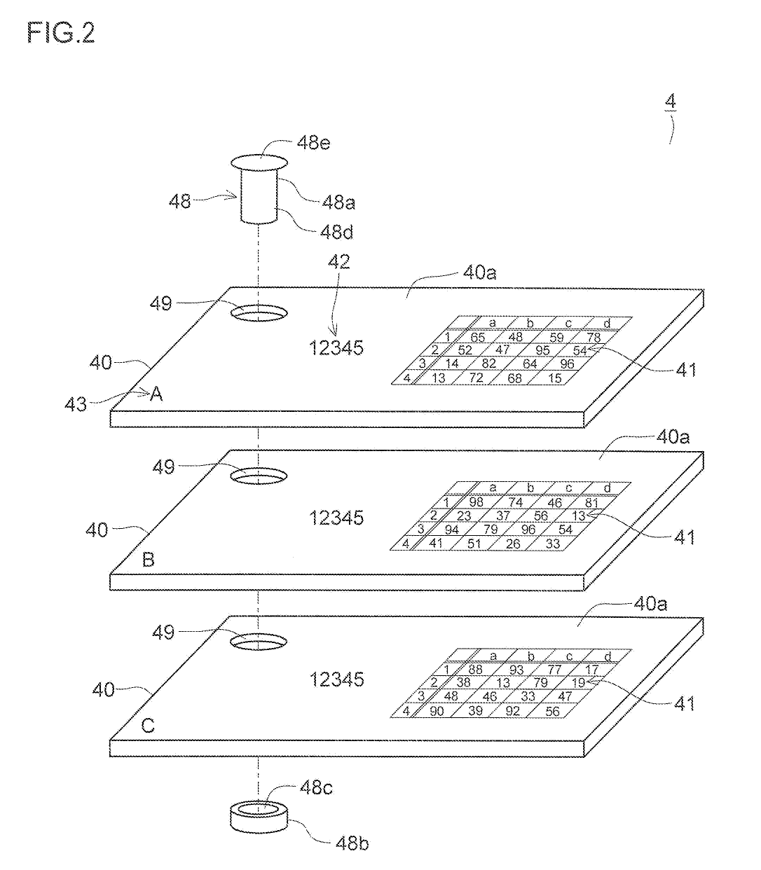

The contractor information storage 23 stores various data about each customer who has signed an Internet banking service contract with the financial institution BK, including contractor number 42 (see FIG. 2), authentication sign table, PIN number (password), name, address, phone number, email address, account information (including branch office, account item, and account number), and the like. The contractor number 42 is a unique number assigned to each customer, and is indicated on a card 40, which will be described later. The authentication sign table contains the same data as a table which is indicated on each card 40 issued for a customer and which has arranged in it a plurality of authentication signs 41 (see FIG. 2).

The user terminal 3 used by a customer comprises a cellular phone such as a smartphone. At the center of a case 30 of the user terminal 3, a display portion 31 is provided, and at the top and bottom of the display portion 31, a speaker 39 and a microphone 38 for conducting a call are arranged respectively. The display portion 31, for example, comprises a liquid crystal panel or the like, and displays operation menus, communication status, and the like. On the display portion 31, an operation portion (input portion) 32 which comprises a touch panel is formed. The user terminal 3 can be connected to the Internet 5 via a communication portion (unillustrated). The user terminal 3 may instead comprise a tablet PC, a personal computer, or the like.

For each customer who has signed the Internet banking service contract with the financial institution BK, a card set 4 is issued by the financial institution BK beforehand. The card set 4 has a plurality of (in this embodiment, three) cards 40. The size of the cards 40 is, for example, substantially equal to the size of a cash card of a bank or the like, and the plurality of cards 40 have different colors from each other. The plurality of cards 40 are vertically stacked on top of another, and are bound together with a binding fastener 48. The binding fastener 48 is composed of a male portion 48a (see FIG. 2) and a female portion 48b (see FIG. 2), which will be described later. The number of cards 40 is not limited to three; it may be any number larger than one.

FIG. 2 is an exploded perspective view of the card set 4. On a right-hand part of a surface 40a of the card 40, the plurality of authentication signs 41 are indicated in a matrix. In this embodiment, the authentication signs 41 are indicated one in each cell of the table with four rows (rows “1” to “4”) by four columns (columns “a” to “d”), that is, a total of sixteen authentication signs 41 are indicated on the card 40. In this embodiment, the authentication signs 41 each comprise a two-digit number (two figures). Instead, the authentication signs 41 may each comprise one figure or comprise any symbols or characters (for example, alphabet letters) other than numbers.

The arrangement (formation) of the plurality of authentication signs 41 is a unique formation assigned to each customer, and differs from one card 40 to another. The table in which the plurality of authentication signs 41 are arranged may have a plurality of rows by a plurality of columns other than four rows by four columns. The plurality of authentication signs 41 may be arrayed, instead of in a matrix, in one column or in one row, or in any other arrangement.

On a left-hand part of the surface 40a of the card 40, the contractor number 42 and a card symbol 43 are indicated. In this embodiment, the contractor number 42 comprises a plurality of figures, namely “12345.” The card symbol 43 is a symbol marked on each card 40 in the card set 4, and in this embodiment, the card symbols 43 each comprise a letter, namely “A”, “B”, or “C”. The contractor number 42 is not limited to numbers; instead, it may include characters (for example, alphabet letters) other than numbers. The card symbol 43 is not limited to alphabet letters; instead, it may comprise any other characters (for example, numbers).

In a left corner part of the card 40, a through hole 49 is provided. The male portion 48a of the binding fastener 48 has a substantially column-shaped insertion portion 48d and an annular flange portion 48e which has a diameter larger than that of the insertion portion 48d and which is provided at the top end of the insertion portion 48d. The female portion 48b is formed in a ring shape to permit the insertion portion 48d to be pressed into it. The flange portion 48e and the female portion 48b are formed to have diameters larger than that of the through hole 49.

Three cards 40 are, for example, stacked on top of one another in the up-down direction such that their card symbols 43 “A”, “B”, and “C” are in this order from top down. Into the through holes 49 in the cards 40, the insertion portion 48d is inserted, and a tip end part of the insertion portion 48d is pressed into a recess 48c in the female portion 48b. In this way, the plurality of cards 40 are stacked and bound together with the binding fastener 48. The plurality of cards 40 can, in the state bound together with the binding fastener 48, rotate about the binding fastener 48 within a plane parallel to the surface 40a. This permits a customer, even with the plurality of cards 40 bound together, to easily check the authentication signs 41 on the cards 40.

The plurality of cards 40 in the card set 4 as initially issued are, for example, stacked on top of one another such that their card symbols 43 “A”, “B”, and “C” are in this order from top down. At the time of issuance of the card set 4, this order is stored in the contractor information storage 23. A customer can freely change the stack order of the plurality of cards 40. By transmitting the changed stack order of the cards 40 to the server 21 through operation on the operation portion 32 of the user terminal 3, it is possible to register the changed stack order in the contractor information storage 23. Then, the stack order registered in the contractor information storage 23 becomes the extraction order of the authentication signs 41 with respect to the plurality of cards 40.

By removing the binding fastener 48 by pulling the insertion portion 48d of the male portion 48a out of the recess 48c, it is possible to keep the cards 40 in the card set 4 separately in different places. This makes it possible to prevent unauthorized use of a stolen card set 4.

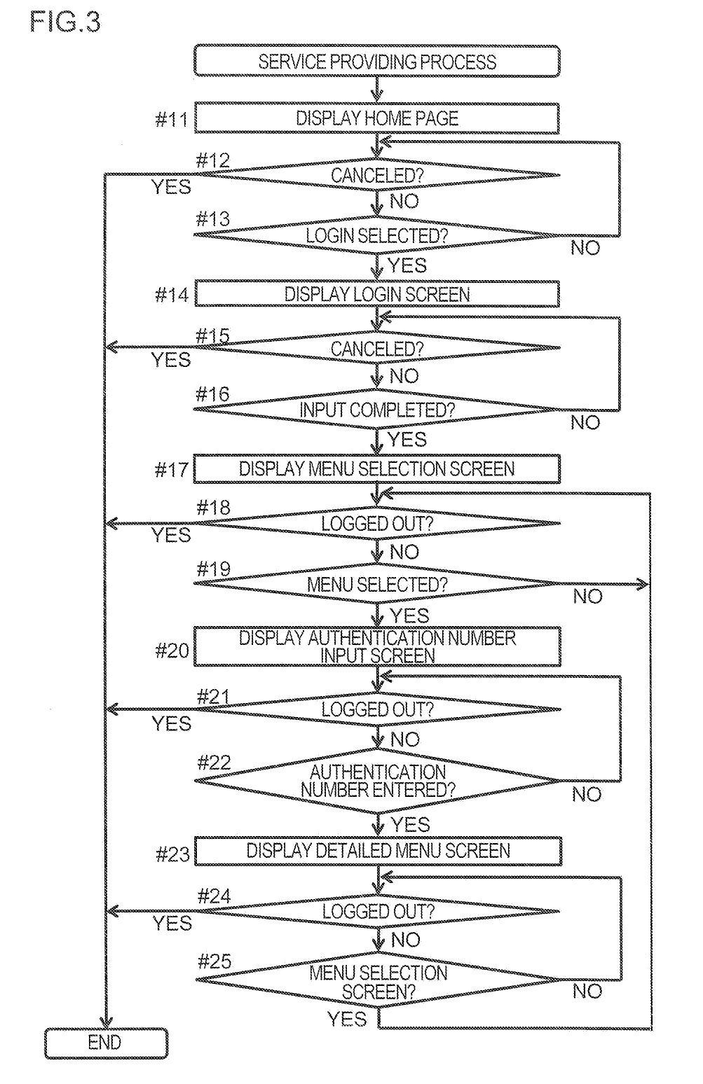

Now, a description will be given of a service providing process for providing Internet banking services in the Internet banking system 1 configured as described above. FIG. 3 is a flow chart showing an example of a service providing process in the Internet banking system 1.

Through operation on the operation portion 32 (see FIG. 1) of the user terminal 3, a user starts a browser, and specifies the URL (uniform resource locator) for the Internet banking website of the financial institution BK. At Step #11, the user terminal 3 receives the data of the Home Page screen (unillustrated) of the Internet banking website from the server 21. Thus, the Home Page screen is displayed on the display portion 31 (see FIG. 1) of the user terminal 3. The Home Page screen includes a menu for selecting Login.

At Step #12, it is checked whether or not a cancel operation for closing the Home Page screen on the user terminal 3 is performed. If the cancel operation is performed, the service providing process ends, and if no cancel operation is performed, the flow proceeds to Step #13.

At Step #13, it is checked whether or not the menu for logging in is selected on the user terminal 3. If the menu for logging in is selected, the flow proceeds to Step #14. If the menu for logging in is not selected, the flow returns to Step #12, so that Steps #12 and #13 are repeated.

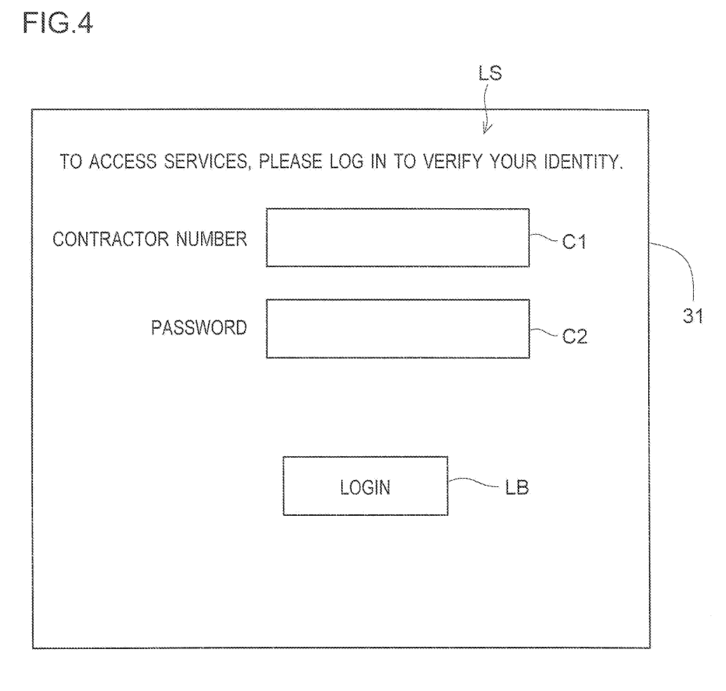

FIG. 4 is a diagram showing an example of a login screen LS (screen for logging in) displayed on the display portion 31 of the user terminal 3 at Step #14. The login screen LS is a screen to log in, and has an input box C1 to enter the contractor number 42, an input box C2 to enter a PIN number (password), and a login button LB. At Step #14, the data of the login screen LS is transmitted from the server 21 to the user terminal 3. The login screen LS is accompanied by a login program configured as a Java (registered trademark) applet. The login program is started immediately after having been received by the user terminal 3, and executes a process for obtaining login authentication from the server 21.

At Step #15, it is checked whether or not a cancel operation for closing the login screen LS is performed. If the cancel operation is performed, the service providing process ends, and if no cancel operation is performed, the flow proceeds to Step #16.

At Step #16, it is checked whether or not the entry of the contractor number 42 and the PIN number is complete. If the entry of the contractor number 42 and the PIN number is complete, the flow proceeds to Step #17, and if the entry of the contractor number 42 and the PIN number is not complete, the flow returns to Step #15, so that Steps #15 and #16 are repeated. Here, the server 21 performs login authentication by checking the contractor number 42 and the PIN number transmitted from the user terminal 3 against the contractor number 42 and the PIN number stored in the contractor information storage 23. “The entry of the contractor number 42 and the PIN number being complete” signifies that the login authentication has succeeded.

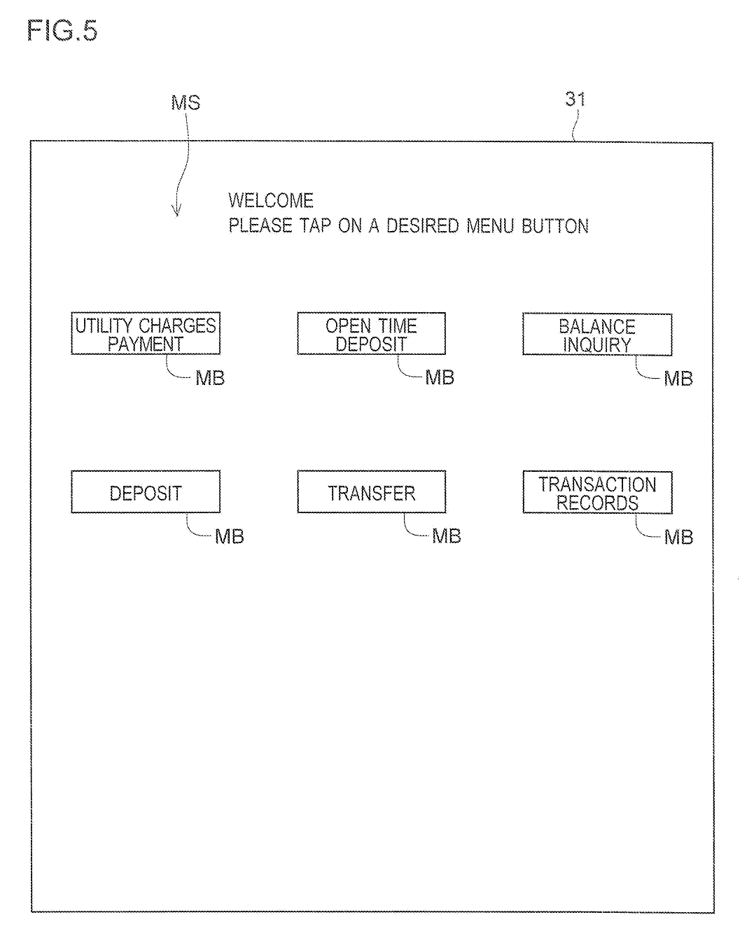

FIG. 5 is a diagram showing an example of a menu selection screen MS displayed on the display portion 31 of the user terminal 3 at Step #17. At Step #17, as a result of logging in on the user terminal 3 being permitted by the server 21, the data of the menu selection screen MS is transmitted to the user terminal 3.

The menu selection screen MS displays a list of menus of the Internet banking services including money transfer, balance inquiry, and the like, and has menu buttons MB showing various menus. In this embodiment, six kinds of menu bottoms MB, namely “Utility Charges Payment,” “Open Time Deposit,” “Balance Inquiry,” “Deposit,” “Transfer,” and “Transaction Records” are displayed on the display portion 31. The menu items are not limited to the above-mentioned six transactions.

At Step #18, it is checked whether or not a logout operation for closing the menu selection screen MS is performed. If the logout operation is performed, the service providing process ends, and if no logout operation is performed, the flow proceeds to Step #19.

At Step #19, it is checked whether or not any of the menu buttons MB is selected on the operation portion 32. If any of the menu buttons MB is selected, the flow proceeds to Step #20. If none of the menu buttons MB are selected, the flow returns to Step #18, so that Steps #18 and #19 are repeated.

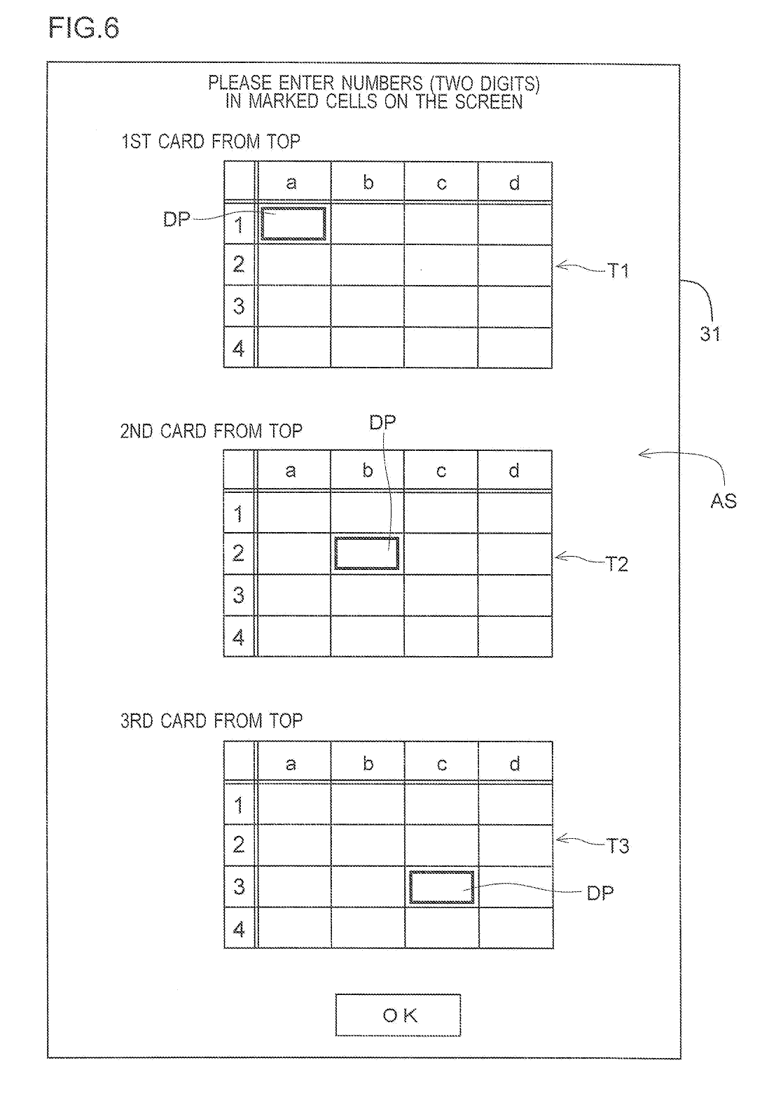

At Step #20, an authentication information input screen AS is displayed on the display portion 31 of the user terminal 3. FIG. 6 is a diagram showing an example of the authentication information input screen AS. The authentication information input screen AS is a screen for entering authentication information required to access the Internet banking services. The authentication information input screen AS has three tables T1 to T3, and the tables T1 to T3 are displayed simultaneously in a vertically-aligned list.

The tables T1 to T3 are displayed like the tables (see FIG. 2) indicated on the cards 40. The tables T1 to T3 are associated with the first, second, and third cards 40 from the top of the card set 4 respectively. For example, the tables T1 to T3 are associated with the cards 40 marked with the card symbols 43 “A”, “B”, and “C” respectively.

At Step #20, the server 21, for example, generates random numbers, and thereby specifies, for each card 40, one designated position DP (cell position) of an authentication sign 41. The designated positions DP on the first, second, and third cards 40 from the top of the card set 4 are specified on the tables T1 to T3 respectively. Then, the entry of the authentication signs 41 at the designated positions DP is requested (a request step).

In the example shown in FIG. 6, the position “a-1” is specified as the designated position DP on the first card 40 (with the card symbol 43 “A”) from the top of the card set 4. The position “b-2” is specified as the designated position DP on the second card 40 (with the card symbol 43 “B”) from the top of the card set 4. The position “c-3” is specified as the designated position DP on the third card 40 (with the card symbol 43 “C”) from the top of the card set 4.

Thus, the entry of “65” (see FIG. 2) which is the authentication sign 41 at the designated position DP, specifically “a-1,” on the first card 40 from the top of the card set 4 is requested. Then, the entry of “37” (see FIG. 2) which is the authentication sign 41 at the designated position DP, specifically “b-2,” on the second card 40 from the top of the card set 4 is requested. Then, the entry of “33” (see FIG. 2) which is the authentication sign 41 at the designated position DP, specifically “c-3,” on the third card 40 from the top of the card set 4 is requested. As a result, the authentication information is “653733.” Here, the entry of the card symbols 43 is not requested.

That is, the authentication information is composed of a plurality of authentication signs 41 extracted from three cards 40 in order of their card symbols 43 “A,” “B,” and “C ” respectively. The server 21 may specify a plurality of designated positions DP on each card 40. The designated positions DP are changed every time the authentication information input screen AS is displayed.

A customer can change the stack order of the cards 40, and then notify the changed order to the financial institution BK via the user terminal 3. Accordingly, the financial institution internal system 2 can register the extraction order of the authentication signs 41 on the plurality of cards 40. For example, in a case where the stack order of the cards 40 of the card set 4 is changed and registered such that their card symbols 43 are in order of “B,” “A,” and “C” from top down, with the same designated positions DP as in FIG. 6, the authentication information is now “984733.” Thus, without increasing the number of authentication signs 41 on each card 40, it is possible to easily increase the variety of the changeable authentication information by changing the extraction order of the authentication signs 41 on the plurality of cards 40.

The actual stack order of the cards 40 of the card set 4 may differ from the extraction order of the authentication signs 41 on the plurality of cards 40. For example, when the actual stack order of the cards 40 is in the order of their card symbols 43 “A,” “B,” and “C” from top down, the extraction order of the authentication signs 41 may be in the order of “B,” “A,” and “C.” The actual stack order of the cards 40 of the card set 4 and the extraction order of the authentication signs 41 on the plurality of cards 40 are preferably the same to reduce the likelihood of erroneous entry by a customer.

At Step #21 in FIG. 3, it is checked whether or not a logout operation for closing the menu selection screen MS is performed. If the logout operation is performed, the service providing process ends, and if the logout operation is not performed, the flow proceeds to Step #22.

At Step #22, it is checked whether or not the entry of the authentication signs 41 at the designated positions DP is all complete. Through operation on the operation portion 32, a customer enters the authentication signs 41 in the cells on the cards 40 corresponding to the cells at the designated positions DP on the tables T1 to T3, and selects the “OK” button (an input step).

Here, the plurality of authentication signs 41 entered from the plurality of cards 40 respectively constitute input information. If the entry of the authentication signs 41 at the designated positions DP is all complete, the flow proceeds to Step #23. If the entry of the authentication signs 41 at the designated positions is not complete, the flow returns to Step #21, so that Step #21 and Step #22 are repeated.

Here, the server 21 checks the authentication signs 41 at the designated positions DP transmitted from the user terminal 3 against the authentication signs 41 at the designated positions DP stored in the contractor information storage 23. In this way, user authentication for permitting access to the Internet banking services is performed.

That is, in the financial institution internal system 2, authentication information is generated from the plurality of authentication signs 41 extracted from the plurality of cards 40 respectively. Then, the input information composed of the plurality of authentication signs 41 entered respectively from the plurality of cards 40 on the operation portion 32 is checked against the authentication information. If the input information matches the authentication information, it is determined that the authentication (user authentication) has succeeded, and if the input information does not match the authentication information, it is determined that the authentication has failed. “The entry of the authentication signs 41 at the designated positions DP being all complete” signifies that the user authentication has succeeded.

At Step #23, a detailed menu screen (unillustrated) related to the menu selected is displayed on the display portion 31. The detailed menu screen has input fields (for example, a money amount field and the like) for entering information related to the menu. Thus, a customer operates the detailed menu screen by use of the operation portion 32, so that the server 21 provides the Internet baking service desired by the customer (a provision step).

For example, when a customer selects the menu button MB of “Transfer” (see FIG. 5), then, at Step #23, the detailed menu screen for “Transfer” is displayed on the display portion 31. The detailed menu screen for “Transfer” has input fields for entering “Money Amount,” “Transfer Destination,” and the like. Thus, the customer can transfer a desired amount of money to a transfer destination by operating the detailed menu screen by use of the operation portion 32.

At Step #24, it is checked whether or not a logout operation for ending the Internet banking service is performed on the user terminal 3. If the logout operation is performed, the service providing process ends, and if no logout operation is performed, the flow proceeds to Step #25.

At Step #25, it is checked whether or not the menu selection screen MS (see FIG. 5) is selected. If the menu selection screen MS is selected, the flow returns to Step #18, so that Step #18 through Step #25 are repeated. If the menu selection screen MS is not selected, the flow returns to Step #24, so that Step #24 and Step #25 are repeated.

An Internet banking system 1 (service providing system) according to this embodiment includes a financial institution internal system (service providing portion) 2 and an operation portion (input portion) 32 of a user terminal 3. The financial institution internal system 2 provides Internet banking services (services) to customers (users). The operation portion 32 is where authentication information is input when the financial institution internal system 2 provides Internet banking services. A plurality of cards 40 on which a plurality of authentication signs 41 are indicated are provided to a customer beforehand, and the authentication information is composed of a plurality of authentication signs 41 extracted from the plurality of cards 40 respectively.

With this configuration, it is possible to easily increase the variety of the changeable authentication information without increasing the number of authentication signs 41 on each card 40. Thus, a third party cannot easily obtain the authentication information, and thus it is possible to prevent fraudulent acquisition of the authentication information like phishing. It is also possible to reduce the likelihood of erroneous entry by a customer misreading the designated positions DP specified by the server 21. Thus, it is possible to improve security while preventing degradation in the usability of the Internet banking system 1.

A card set 4 which has a plurality of cards 40 is issued for a customer beforehand; this makes it unnecessary to reissue another card 40 for increasing the variety of the changeable authentication information.

The financial institution internal system 2 can register the extraction order of the authentication signs 41 on the plurality of cards 40. This makes it possible to easily increase the variety of the changeable authentication information, and thus helps improve the security of the Internet banking system 1.

The plurality of cards 40 are stacked and bound together. This makes it possible to keep the plurality of cards 40 together easily and thus to prevent a loss of individual cards 40.

The financial institution internal system 2 may instruct the user terminal 3 on the order (stack order) in which the plurality of cards 40 are stacked together. Then, the positions (cells) at which the authentication signs 41 on the cards 40 are to be extracted may be notified in the stack order of the cards 40 via the display portion 31 of the user terminal 3. This permits the financial institution internal system 2 to prompt a customer to change the stack order of the cards 40, and thus helps further improve the security of the Internet banking system 1.

In the financial institution internal system 2, authentication information is generated from the plurality of authentication signs 41 extracted from the plurality of cards 40 respectively. Then, the input information composed of the plurality of authentication signs 41 entered respectively from the plurality of cards 40 on the operation portion 32 is checked against the authentication information. Then, if the input information matches the authentication information, it is determined that the authentication has succeeded, and if the input information does not match the authentication information, it is determined that the authentication has failed. Thus, it is possible to easily perform the user authentication based on the check of the input information against the authentication information composed of the plurality of authentication signs 41 extracted from the plurality of cards 40 respectively.

In this embodiment, the operation portion (input portion) 32 is provided on the user terminal (information terminal) 3 connected to the financial institution internal system 2 via the Internet 5. Thus, it is possible to increase the variety of the changeable authentication information while improving the convenience of the Internet banking system 1, and thus to prevent damage caused by phishing sites.

The card set 4 is composed of a plurality of cards 40 on which a plurality of authentication signs 41 forming the authentication information are indicated in a dispersed manner. Thus, it is possible to easily increase the variety of the changeable authentication information without increasing the number of authentication signs 41 on each card 40.

A request step where the entry of the authentication information is requested when the services are provided, and an input step where the authentication information is entered on the operation portion (input portion) 32 are performed. Then, a provision step where the services are provided by the financial institution internal system (service providing portion) 2 based on the authentication information entered at the input step is performed. The plurality of cards 40 on which the authentication signs 41 are indicated are provided to a user beforehand, and the authentication information is composed of the plurality of authentication signs 41 extracted from the plurality of cards 40 respectively. Thus, it is possible to improve security while preventing degradation in the usability of the Internet banking system 1.

### Second Embodiment

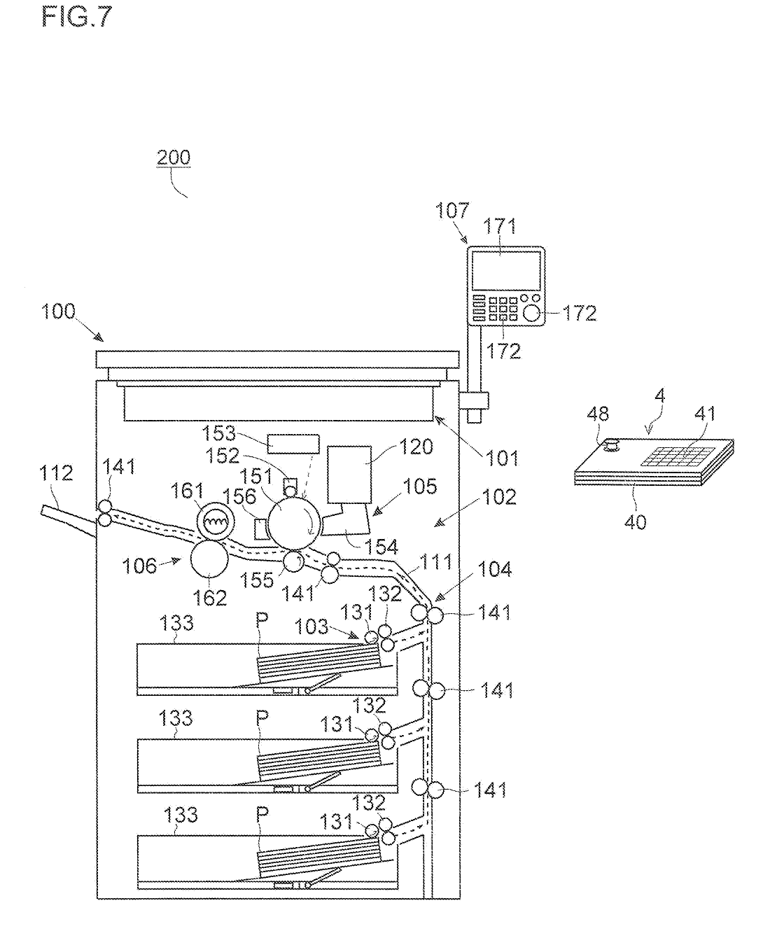

Now, a second embodiment of the present disclosure will be described. FIG. 7 is a diagram showing an outline of a construction of an image forming system (service providing system) 200 according to this embodiment. For the sake of convenience of description, such components as find their counterparts in the first embodiment shown in FIGS. 1 to 6 are identified by the same reference signs. This embodiment differs from the first embodiment in that a service providing portion comprises a multifunction peripheral 100. Otherwise, the configuration in the second embodiment is similar to that in the first embodiment. FIG. 7 is a side view showing the inside of the multifunction peripheral 100.

The image forming system 200 includes the multifunction peripheral 100, an operation panel (input portion) 107, and a card set 4. The multifunction peripheral (service providing portion) 100 includes an image reading portion 101 and a printing portion 102, and has the functions of a scanner, a copier, and a facsimile machine. The multifunction peripheral 100 provides an image forming service for forming images. The image reading portion 101 reads a document and generates its image data. The printing portion 102 conveys a sheet P along a sheet conveyance passage 111, and forms a toner image based on the image data. The printing portion 102, while conveying the sheet P, prints the toner image on the sheet P, and discharges the sheet P having undergone printing onto a discharge tray 112.

The printing portion 102 includes a sheet feeding portion 103, a sheet conveying portion 104, an image forming portion 105, and a fixing portion 106. The sheet feeding portion 103 includes a pick-up roller 131 and a sheet feeding roller pair 132, and feeds sheets P, which are stored in a sheet cassette 133, into the sheet conveyance passage 111. The sheet conveying portion 104 includes a plurality of conveying roller pairs 141, and conveys a sheet P along the sheet conveyance passage 111.

The image forming portion 105 includes a photosensitive drum 151, a charging device 152, an exposing device 153, a developing device (developing portion) 154, a transfer roller 155, and a cleaning device 156.

In image formation, as the photosensitive drum 151 rotates, the surface of the photosensitive drum 151 is electrostatically charged by the charging device 152. The exposing device 153 exposes the surface of the photosensitive drum 151 to light, and thereby forms an electrostatic latent image on the surface of the photosensitive drum 151. The developing device 154 feeds toner to the electrostatic latent image formed on the surface of the photosensitive drum 151, and thereby develops the electrostatic latent image into a toner image.

The transfer roller 155 is in pressed contact with the surface of the photosensitive drum 151, and forms a transfer nip with the photosensitive drum 151. As the sheet P enters the transfer nip, the toner image on the surface of the photosensitive drum 151 is transferred to the sheet P. The cleaning device 156 removes toner and the like remaining on the surface of the photosensitive drum 151.

The fixing portion 106 includes a heating roller 161 and a pressing roller 162. The heating roller 161 incorporates a heat source. The pressing roller 162 is in pressed contact with the heating roller 161, and forms a fixing nip with the heating roller 161. The sheet P having the toner image transferred to it passes through the fixing nip to be heated and pressed there. Thereby, the toner image is fixed to the sheet P, and the printing is complete.

Toner is stored in the developing device 154, but the toner is consumed as printing is performed, and thus it is necessary to supply fresh toner to the developing device 154. To that end, in the multifunction peripheral 100, a container 120 for storing toner for replenishment is provided so as to be removable from an apparatus main body. This makes it easy to replace the container 120. When it is detected by a remaining amount sensor (unillustrated) that the amount of toner remaining in the developing device 154 has fallen below a predetermined amount, toner is supplied from the container 120 to the developing device 154.

The operation panel 107 is fitted to the multifunction peripheral 100, and includes a liquid crystal display panel 171 with a touch panel. The liquid crystal display panel 171 displays messages and software keys to receive various settings. For example, the liquid crystal display panel 171 displays a login screen LS (see FIG. 4), a menu selection screen MS (see FIG. 5), an authentication information input screen AS (see FIG. 6), and the like. The operation panel 107 is also provided with hardware keys 172 such as a Start key and a numeric keypad.

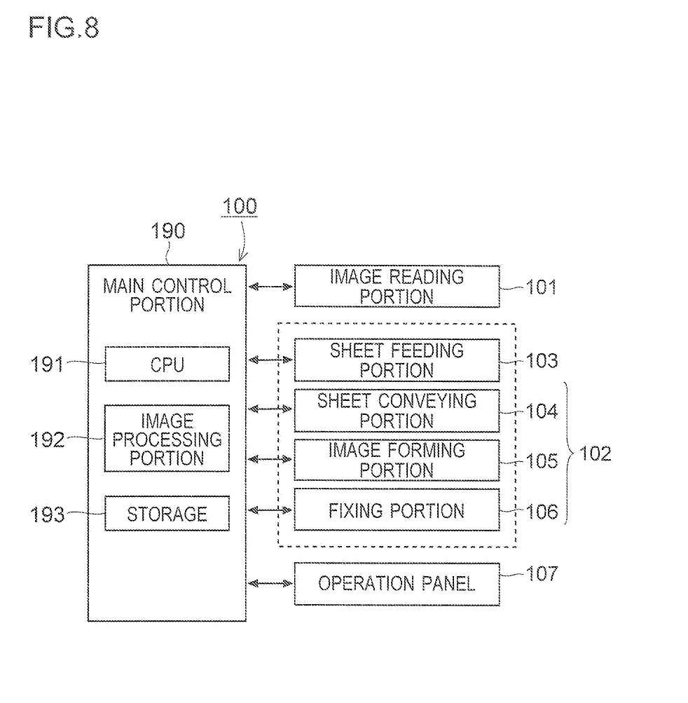

FIG. 8 is a block diagram showing a configuration of the multifunction peripheral 100. The multifunction peripheral 100 includes a main control portion 190. The main control portion 190 includes a CPU 191, an image processing portion 192, and a storage 193. The image processing portion 192 comprises an ASIC or the like dedicated to image formation, and subjects image data to image processing (such as scale enlargement and reduction, density conversion, and data format conversion). The storage 193 comprises, for example, ROM, RAM, or the like, and stores controlling programs and various data. Data stored in the storage 193 includes contractor numbers 42, PIN numbers (passwords), tables of a plurality of authentication signs 41 indicated on cards 40 in the card set 4 (authentication sign tables), extraction orders of the authentication signs 41 on the plurality of cards 40, and the like.

The main control portion 190 controls the operation of the multifunction peripheral 100 based on the programs and various data stored in the storage 193. Specifically, the main control portion 190 is connected to the image reading portion 101 and the printing portion 102 (including the sheet feeding portion 103, the sheet conveying portion 104, the image forming portion 105, and the fixing portion 106), and controls reading operation and printing operation. The main control portion 190 is also connected to the operation panel 107, and controls display on the operation panel 107 and detects operation performed on the operation panel 107. The main control portion 190 generates random numbers to specify designated positions DP, and also performs login authentication, user authentication based on authentication information, and the like.

Now, a description will be given of a service providing process for providing image forming services in the image forming system 200 configured as described above. The service providing process according to this embodiment proceeds in a similar manner as in the first embodiment shown in FIG. 3 except that previously-described Step #11 to Step #13 in FIG. 3 are omitted. When the power to the multifunction peripheral 100 is turned on, at Step #14, the login screen LS (see FIG. 4) is displayed on the liquid crystal display panel 171.

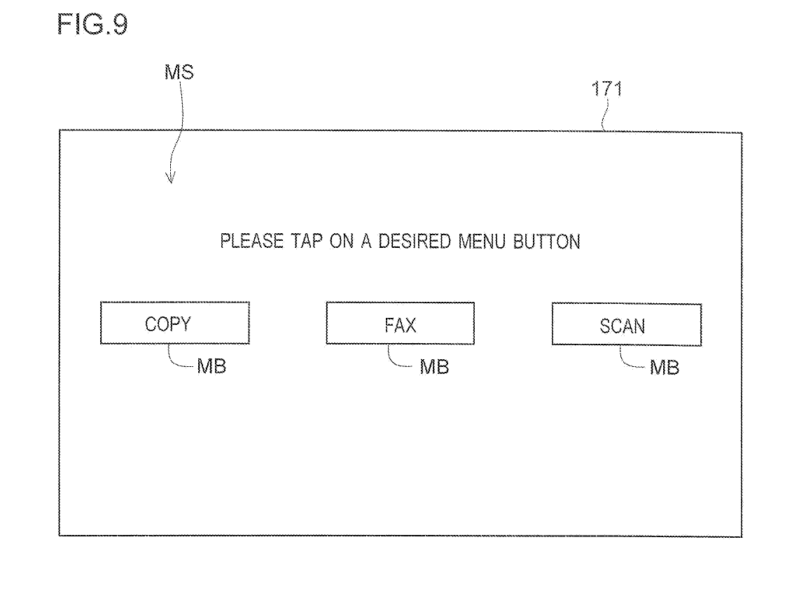

At Step #17, the menu selection screen MS shown in FIG. 9 is displayed on the liquid crystal display panel 171. The menu selection screen MS has menu buttons MB, namely “Copy,” “Fax,” and “Scan.”

For example, at Step #19, if the menu button MB of “Copy” is selected, then at Step #23, a detailed menu screen (unillustrated) for “Copy” is displayed on the liquid crystal display panel 171. The detailed menu screen for “Copy” has input fields for entering number of copies, sheet size, and the like. Thus, a customer can, by operating the detailed menu screen, receive the image forming service.

With this embodiment, it is possible to obtain an effect similar to that obtained in the first embodiment. The image forming services are provided by the multifunction peripheral (service providing portion) 100 in the image forming system (service providing system) 200. This helps improve security when an image forming service is provided for a classified document or the like.

The image forming system 200 according to this embodiment may include a user terminal similar to the user terminal 3 according to the first embodiment. In this case, the multifunction peripheral 100 and the user terminal can be configured to be able to communicate with each other via a communication portion. Here, the multifunction peripheral 100 and the user terminal are connected to a predetermined network (for example, a local area network or the like). The user can then transmit image data from the user terminal to the multifunction peripheral 100 to receive the image forming services. The multifunction peripheral 100 and the user terminal may be paired together via a wireless standard such as Bluetooth (registered trademark).

The embodiments described above are in no way meant to limit the present disclosure, which thus allows for many modifications and variations within the spirit of the present disclosure. For example, although the second embodiment deals with the multifunction peripheral 100 as an example of a service providing portion, the service providing portion is not limited to the multifunction peripheral 100; it may instead be another type of apparatus (for example, medical equipment or the like).

In the first and second embodiments, in login operation, the authentication information input screen AS (see FIG. 6) may be displayed on the display portion 31 of the user terminal 3 or the liquid crystal display panel 171, and the entry of the authentication signs 41 on the cards 40 may be requested there. In the present specification, the “login operation” is included in the services provided.

Although, on the authentication information input screen AS according to the first and second embodiments, tables T1 to T3 corresponding to three cards 40 are simultaneously displayed in a list; instead, the tables T1 to T3 may be displayed one at a time and switched among them each time the entry of an authentication sign 41 for the displayed table is complete.

Although, in the first and second embodiments, the authentication information is composed of a plurality of authentication signs 41 extracted from all of a plurality of cards 40, the authentication information does not necessarily have to be extracted from all of the plurality of cards 40. For example, the authentication information may be composed of a plurality of authentication signs 41 extracted from three cards 40 out of five cards 40. In this case, the extraction order of the authentication signs 41 on the three cards 40 may be previously registered in the financial institution internal system 2.

The present disclosure is applicable to a service providing system using cards and to a card set used in a service providing system. Based on the present disclosure, it is possible to improve security while preventing degradation in the usability of a service providing system.

What is claimed is:

1. A service providing system comprising:
a service providing portion which provides a predetermined service to a user; and
an input portion to which authentication information is input when the service providing portion provides the service, wherein
authentication is performed based on the authentication information, and
the authentication information is composed of a plurality of authentication signs extracted, respectively, from a plurality of cards which are provided to the user beforehand and on which a plurality of authentication signs are indicated.

2. The service providing system of claim 1, wherein
the service providing portion is capable of registering an extraction order of the authentication signs on the plurality of cards.

3. The service providing system of claim 1, wherein
the plurality of cards are stacked and bound together.

4. The service providing system of claim 1, wherein
the service providing portion
instructs the input portion on an order in which the plurality of cards are stacked together, and
notifies, in the stack order of the cards, positions at which the authentication signs are extracted from the cards.

5. The service providing system of claim 1, wherein
the service providing portion
generates the authentication information from the plurality of authentication signs extracted from the plurality of cards,
checks input information composed of the plurality of authentication signs input from the plurality of cards to the input portion against the authentication information,
determines, if the input information matches the authentication information, that the authentication has succeeded, and
determines, if the input information does not match the authentication information, that the authentication has failed.

6. The service providing system of claim 1, wherein
the input portion is provided on an information terminal connected to the service providing portion via a predetermined network.

7. The service providing system of claim 6, wherein
the service providing portion provides an Internet banking service.

8. The service providing system of claim 6, wherein
the service providing portion provides an image forming service.

9. A card set composed of a plurality of cards on which a plurality of authentication signs, which forms authentication information required when a service is provided by a service providing portion providing a predetermined service to a user, are indicated in a dispersed manner.

10. The card set of claim 9, wherein
the plurality of cards are stacked and bound together.

11. A method for providing a service in a service providing system including a service providing portion providing a predetermined service to a user and an input portion to which authentication information is input when the service providing portion provides the service, authentication being performed based on the authentication information, the method comprising:
requesting entry of the authentication information when the service is provided;
inputting the authentication information to the input portion; and
providing the service by the service providing portion based on the authentication information input, wherein
the authentication information is composed of a plurality of authentication signs extracted from a plurality of cards which are provided to the user beforehand and on which the plurality of authentication signs are indicated.
